(19) United States
(12) Patent Application Publication
(10) Pub. No.: US 2002/0098033 A1
(43) Pub. Date: Jul. 25, 2002

(54) Construction of tie rod bushing for ball joint

(75) Inventor: Sergio Cardoso, Sao Bernardo do Campo (BR)

Correspondence Address: Liniak, Berenato, Longacre & White, Ste. 240, 6550 Rock Spring Drive, Bethesda, MD, 20817, US

(73) Assignee: DANA INDUSTRIAL S/A

(21) Appl. No.: 10/053,686

(22) Filed: Jan. 24, 2002

(30) Foreign Application Priority Data
Jan. 24, 2001 (BR) PI 0100427-1

(51) Int. Cl. F16C 11/06

(52) U.S. Cl. 403/56

(57) ABSTRACT

An integral tie-rod construction with application of polymer composites with fibers reinforcements, having a stem connecting two ball joints integrally formed at opposite ends. The tie rid and ball joints are integrally formed of a single piece of a fiber-reinforced copolymer. The ball joints may either directly engage a ball pin surface or include a bearing member disposed there between. The bearing member is also preferably made of a fiber-reinforced co-polymer.

### BACKGROUND OF THE INVENTION

1. Field of the Invention

This invention refers to a construction of a tie-rod with the application of polymer composites with fiber reinforcement, and more particularly to a tie rod stem that links two ball joints, with the function of fixing and transmitting movements and efforts of other mechanical components, for application in automotive vehicles.

2. Background of the Related Art

Ball joints are composed, in general, of a box with a housing in its interior, in cylindrical shape, where is introduced a bearing, single or in two pieces, that shapes a ball pin, being that the assembly, mounted, has the function of providing, both angular and rotating movements between two pieces, which are fixed, one to the ball joint box and other to the ball pin body, which by its turn, projects itself through an opening existent in the ball joint box. Thus, the ball pin body is fixed to one part or component of a mechanical system and the ball joint box is fixed to another part or component of the same mechanical system, and, the ball joint fixed in this way releases the angular and rotating movement of both parties around the ball of the joint, supporting the efforts that are concentrated therein.

The tie-rod, to which this invention refers, as above mentioned, is constituted by a stem and two joints, provided at their extremities, as an integral part of the stem, being that only the body of the ball pins of each joint is fixed to different parts or components of the mechanical system, connecting them and releasing the angular and rotating movement between these two pieces, besides supporting the strains that are therein concentrated. These tie-rods are of fixed length, that is, distance between the centers of the fixed ball pins, as the stem and the ball joints of their extremities constitute a single piece. Having in mind the need of supporting strains transmitted by the pieces that are fixed to the pins of the ball joints existent in the extremities of the stem, these tie-rods, in the current state of the art, have stems constructed of metallic material, such as steel, for example, and are fixed to the ball joints by weld. It happens that the dynamics of the technological development existent, mainly in the automotive sector, tends to demand at every day, new developments that assure better quality, greater durability and lower cost, and, specifically, lower weight, with the objective of more and more improving the weigth/power ratio of the automotive vehicles, what is translated in lower spending of energy with obvious economic consequences. Because of this, the tie-rods with metallic material stems become components undesirable to the new developments, as, to support strains these stems need to be resistant and the resistance to the metallic material utilized result in excessive weight, what counters the desired expectations.

### SUMARRY OF THE INVENTION

The present invention aims to solve these inconveniences, presenting a tie-rod constituted of a single piece, namely, stem and ball joints of their extremities, constitute a single piece, of a material based on polymer composites with fibers reinforcements. As a construction option, the tie-rods object of this invention may be presented with the ball pin directly mounted in the interior of the ball joint box, constructed with the material based on polymer composites with fibers reinforcements, without the use of bearing, or, mounting the ball pin in a proper bearing and the assembly in the interior of the ball joint constructed with the material based on polymer composites with fibers reinforcements. The technical effects arisen of this new construction are translated in the following advantages, as compared to the state of the art, that utilizes in the manufacture of the stems and ball joints, steels or other types of materials: reduction in the final weight of the assembly, increasing of the mechanical resistance, increasing of the resistance to fatigue, dimensional stability, resistance to the corrosion and low concentration of strains.

### BRIEF DESCRIPTION OF THE DRAWINGS

The attached drawings present preferred embodiments of the invention, in which:

FIG. 1 is a partial sectional view of a tie-rod without bearing in accordance with the present invention; and

FIG. 2 is a partial sectional view of a tie-rod assembly according to an alternate embodiment of the present invention.

### DETAILED DESCRIPTION OF THE PREFERRED EMBODIMENTS

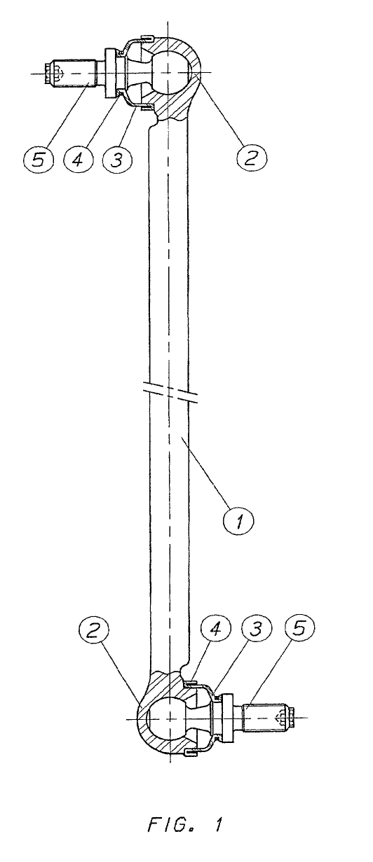

As it is seen in the attached drawings, the tie-rod without bearing presented in the FIG. 1 is composed by a stem (1), constructed with material based on polymer composites with fibers reinforcements, which features in its extremities, as an integral part, constituting a single piece, ball joints (2) that are composed by protection cap (3), sealing ring (4) and ball pin (5).

In this embodiment, the stem 1 and ball joint portion 2 covering the ball pin 5 is made of a single piece homogenously formed of a copolymer fiber reinforced resin. The ball joint portion 2 has an inner surface contoured to correspond to an outer surface of a ball portion of ball pin 5. The inner surface of the ball joint 2 engages and bears directly against the outer surface of the of the ball portion of ball pin 5 eliminating a need for an additional bearing member.

The single piece integral nature of the tie rod of the present invention homogeneously formed of a copolymer fiber reinforced resin reduces the final weight of the tie-rod, increase their mechanical resistance, increase their resistance to fatigue, and, provides dimensional stability, corrosion resistance and low concentration of strains, and simplifies the overall construction of the entire linkage assembly.

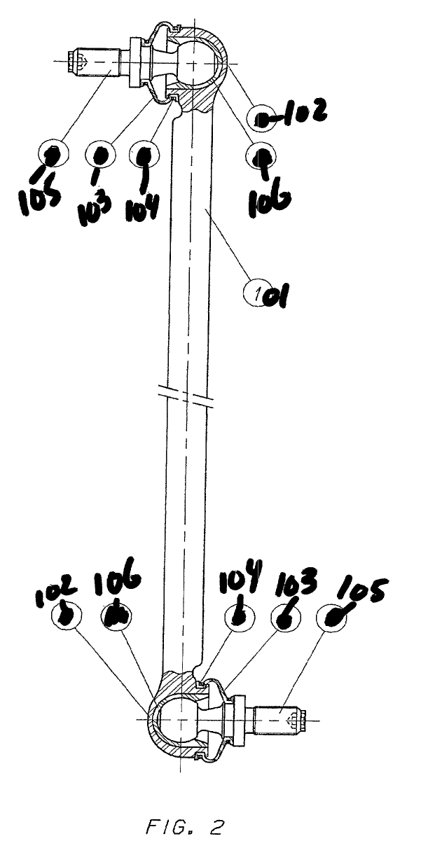

FIG. 2 represents an alternate embodiment of the present invention incorporating a bearing member 106 disposed between the ball portion of the ball pin 105 and the inner surface of the ball joint 102. The tie-rod with bearing 106 shown in FIG. 2 is composed by a stem 101, similarly constructed with material based on polymer composites with fibers reinforcements, that features in its extremities, as an integral part, constituting a single piece, ball joints 102, composed by bearing member 106, protection cap 103, sealing ring 104 and ball pin 105.

As in the previous embodiment the stem 101 and ball joint portion 102 are integrally formed of a copolymer fiber reinforced resin to form a homogenous single piece member.

While the foregoing invention has been shown and described with reference to a preferred embodiment, it will be understood by those possessing skill in the art that various changes and modifications may be made without departing from the spirit and scope of the invention.

1. A tie-rod integrally made of polymer composites with fiber reinforcements, said tie rod comprising: a stem that has in its extremities as an integral part, a single piece, a pair of ball joint composed of a box, a protection cap and ball pin, the tire rod provided to form a part of a mechanical system to provide relative angular and rotating movement between a pair of ball pin members.

2. The tie rod according to claim 1, further comprising said ball pin members each having a ball surface engagingly disposed within a corresponding one of said boxes; and
a bearing member disposed between each of said boxes and a corresponding one of said ball pin members.

3. A tie rod linkage assembly comprising:
a stem having a pair of ball joint portions one formed on opposite ends of said stem, said stem and said ball joint portions being homogenously formed as an integral single piece of a fiber reinforced copolymer; and
a pair of ball pins each having a ball surface disposed within a corresponding one of said ball joint portions thereby providing a connection between said ball pins and said tie rod and permitting relative angular and rotating movement therebetween.

4. The tie rod linkage assembly according to claim 3, further comprising:
a bearing member disposed between said ball surfaces and said ball joints.

5. The tie rod linkage assembly according to claim 4, where in said bearing member is formed of a fiber reinforced copolymer.

6. The tie rod linkage assembly according to claim 3, wherein said ball joint portions have an inner surface contoured in corresponding relationship with said ball surface and being in direct engagement thereto.

7. The tie rod linkage assembly according to claim 3, said assembly further comprising:
a protection cap one each secured to said ball joints and corresponding ball pin thereby sealing an engagement interface between said ball pin and said ball joint from an external environment.
